(19) United States
(12) Patent Application Publication
(10) Pub. No.: US 2008/0272053 A1
(43) Pub. Date: Nov. 6, 2008

(54) COMBINATORIAL SEPARATIONS AND CHROMATOGRAPHY RENEWABLE MICROCOLUMN

(76) Inventor: Darrell P. Chandler, Manchester, MI (US)

Correspondence Address: JOAN PENNINGTON, 535 NORTH MICHIGAN AVENUE, UNIT 1804, CHICAGO, IL, 60611, US

(21) Appl. No.: 11/742,903

(22) Filed: May 1, 2007

(51) Int. Cl. B01D 15/08

(52) U.S. Cl. 210/658; 210/198.2

(57) ABSTRACT

A renewable chromatography structure and methods of the invention for manipulating and trapping small particles within microfluidic systems enable providing surface-functionalized particles that are smaller than the fluidic tolerances of the microfluidic column. Particles of varied chemistry are then utilized for physical or mechanical packing, filtration, separations, modifying fluidic or flow properties of the renewable chromatography column.

The United States Government has rights in this invention pursuant to Contract No. W-31-109-ENG-38 between the United States Government and The University of Chicago and/or pursuant to Contract No. DE-AC02-06CH11357 between the United States Government and UChicago Argonne, LLC representing Argonne National Laboratory.

### FIELD OF THE INVENTION

The present invention relates to a renewable chromatography column that comprises a mixture of materials that have different physiochemical properties, and more particularly to a renewable chromatography column, and a method of using of the column to capture specific molecules and advantageously automated and performed in a microfluidic environment.

### DESCRIPTION OF THE RELATED ART

Particles have a long history of use in the fields of chemical and biological separations or sample preparation, where the particles simplify the separations procedure by capturing or retaining one or more analytes of interest on the particle surface or within the pore spaces formed by a packed column. Particles are also used in other analytical techniques; for example, as a sensor element or part of a detection system. Continued interest in autonomous, point-of-use, or microfluidic sample-to-answer analytical systems has resulted in new applications for particle separations and manipulations, where the particles of interest are frequently less than 1 mm in cross-section or diameter and frequently less than 5 microns in cross-section or diameter.

Many assays that are designed to detect and/or capture particular biomolecules use some type of material for which such biomolecules have an affinity. This material often comprises beads or particles of different sizes or shapes having different chemical and physical characteristics. In some cases, the physiochemical properties of a specific particle material limit its use in the separations process or within an integrated, sample-to-answer fluidic device.

Silica particles less than 5 microns in cross-section or diameter that are frequently used for nucleic acid purification, for example, tend to clog upon the exchange of chaotropic salts with a wash solution, leading to excessive backpressure that limits the particle's use in low-pressure, microfluidic devices. Within the broader context of biological detection systems, there is also increasing interest in systems for the simultaneous, sample-to-answer detection and analysis of differing classes of molecules; e.g. nucleic acids (DNA and RNA), proteins, lipids, carbohydrates and/or small molecules (biological toxins, organic and inorganic chemicals), each of which is typically isolated and purified from sample mixtures using different types of particles and processes.

Prior art approaches the problem of multi-analyte sample preparation in either parallel (split-sample) sample processors (e.g. separate channels for nucleic acid, protein or small molecule isolation and purification) or as a series of sequential (single-tube or single-column) separation functions. Conventional liquid chromatography (LC) and high pressure liquid chromatography (HPLC) systems, microfluidic “chip”-based separations and systems, or renewable surface separations and systems are all representative of prior art.

U.S. Pat. No. 6,136,197, to Egorov et al., issued Oct. 24, 2000, discloses system for column-based separations, methods for forming packed columns, methods of unpacking columns, and methods of separating or purifying sample components.

U.S. Pat. No. 7,090,774, to Holman et al., issued Aug. 15, 2006, and U.S. patent application US 2006/0096903 A1, a divisional patent application of U.S. Pat. No. 7,090,774, discloses a method of packing and unpacking a column chamber. A mixture of a fluid and a matrix material are introduced through a column chamber inlet so that the matrix material is packed within a column chamber to form a packed column. After the packing, the matrix material is unpacked from the column chamber without moving the column chamber. The column chamber having the column chamber inlet or first port for receiving the mixture further has an outlet port and an actuator port. The outlet port is partially closed for capturing the matrix material and permitting the fluid to flow there past by rotating relative one to the other of a rod placed in the actuator port. Further rotation relative one to the other of the rod and the column chamber opens the outlet and permits the matrix material and the fluid to flow there through thereby unpacking the matrix material from the column chamber. A method is provided for purifying a component of a sample. A column chamber having an inlet end, an outlet end and an actuator end is provided. Flow of matrix material is obstructed by a rod with a binary end inserted in the actuator end. A suspension of the first fluid and the matrix material is flowed into the column chamber to form a packed column of the matrix material within the column chamber. The matrix material is configured to selectively retain a component of the sample. The sample is flowed through the packed column and past the rod to separate the component from the rest of the sample. The rod or the column chamber is rotated with respect to the other to open the outlet end and to remove the matrix material from the column chamber. A system for column-based separations comprises a fluid passageway containing a column chamber and a flow path in fluid communication with the column chamber. The flow path is partially obstructed by a rod. The flow path extends through the column chamber and through the outlet end. The flow path is configured to form a packed column within the column chamber when a suspension of the fluid and the column matrix material is flowed along the flow

U.S. patent application US 2003/0164335 A1 to Grate et al., published Sep. 4, 2003, a continuation-in part patent application of U.S. Pat. No. 7,090,774, discloses a method for manipulating small particles in a microfluidic system wherein a fluid flow through a tolerance of the microfluidic system is used to capture large particles, which are then used, in turn, to capture small particles.

A principal aspect of the present invention is to provide a renewable chromatography column, and methods of using of the column to capture specific molecules and advantageously is automated and performed in a microfluidic environment.

Other important aspects of the present invention are to provide such renewable chromatography column, and methods of using of the column to capture specific molecules substantially without negative effect and that overcome some of the disadvantages of prior art arrangements.

As used in the following description and claims, it should be understood that the term “selected molecules” includes biological molecules including intact microorganisms (bacteria, viruses, fungi) or cell suspensions; nucleic acids (DNA or RNA nucleotides or polynucleotides); enzymes; proteins; peptides; lipoproteins; lipids; carbohydrates; and small molecules produced by biological activity, for example, toxins, antibiotics, primary and secondary metabolites.

As used in the following description and claims, it should be understood that the term “particle” includes cells, fungi, bacteria, viruses, or biological complexes; and organic and inorganic compounds such as polymers, hydrogels, metal oxides, glass, ceramics, metals, carbon, liposomes or other synthetic conglomerates.

### SUMMARY OF THE INVENTION

In brief, a renewable chromatography structure, and methods of using of the renewable chromatography structure, such as a renewable chromatography column are provided to capture specific molecules in a microfluidic environment.

A renewable chromatography structure and methods of the invention for manipulating and trapping small particles within microfluidic systems enable providing surface-functionalized particles that are smaller than the fluidic tolerances of the microfluidic column. Particles of varied chemistry are utilized for physical or mechanical packing, filtration, modifying fluidic or flow properties of the renewable chromatography column.

In accordance with features of the invention, discreet chromatography particle layers are separated for selectively performing discreet chromatographic functions in series, in combination, or in both series and combination. Discreet chromatography layers are separated for combining multiple, physical and chromatographic functions within a single column.

In accordance with features of the invention, a mixture of different materials that have selected properties is used to capture the desired biomolecules in a renewable column. In one embodiment the renewable column is connected to ports that can be switched, allowing the cleaning and refilling of the column via automation. Each time the column is refilled, a different mixture of materials advantageously is used allowing for the automation of multiple steps in the preparation of a sample.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A, 1B, 1C, and 1D illustrate a rotating rod renewable microcolumn for implementing methods in accordance with the preferred embodiment;

FIG. 2 illustrates the identical functionality within an injection-molded microfluidic piece rather than a renewable microcolumn in a “layered” deposition strategy of FIGS. 1A, 1B, 1C, and 1D; and

FIG. 3 illustrates a combinatorial filtration microcolumn for implementing methods in accordance with the preferred embodiment.

### DETAILED DESCRIPTION OF THE PREFERRED EMBODIMENTS

In accordance with features of the invention, a combinatorial chromatography column comprises a mixture of materials that have different physiochemical properties in order to achieve a combinatorial separations scheme within a single column. The column can be automated and performed in a microfluidic environment, either as a single-use microcolumn or as a renewable-surface microcolumn.

In accordance with features of the invention, methods of the invention are especially useful for biological separations and detection.

In accordance with features of the invention, there are multiple functions or uses of particles in separations and chromatography. The combinatorial microcolumn of the invention addresses the following functions: Physical/mechanical packing and column formation including particles less than 5 microns in cross section, and two or more particles of differing physiochemical composition within a single chamber or column. Additional combinatorial microcolumn features include physical/mechanical filtration, modifying flow properties around the particles of interest; and combinatorial chemical separations including separating chromatographic layers or sections within a single column; and performing multiple chemistries simultaneously within a single column.

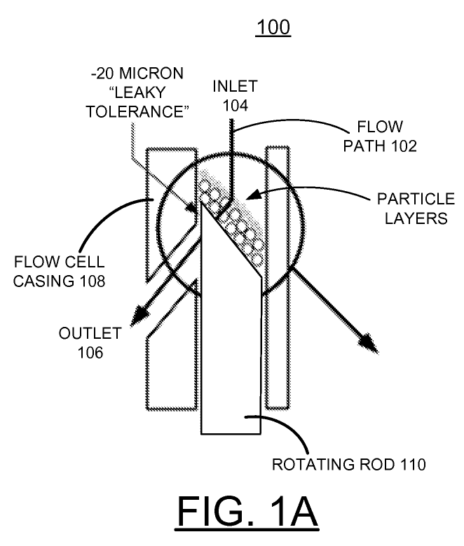

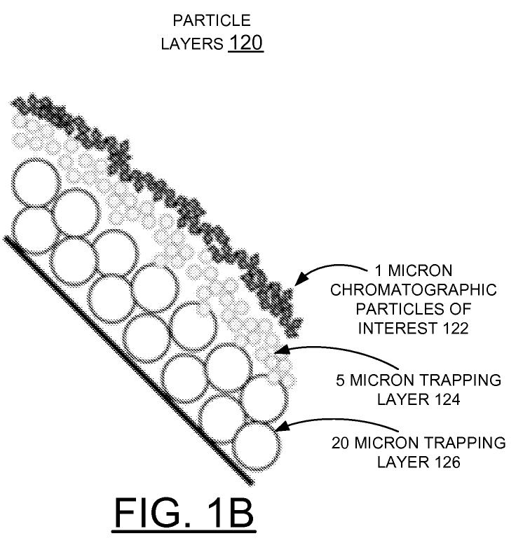

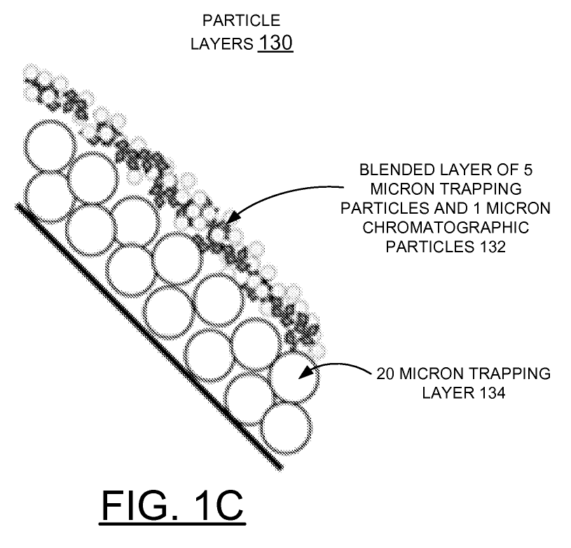

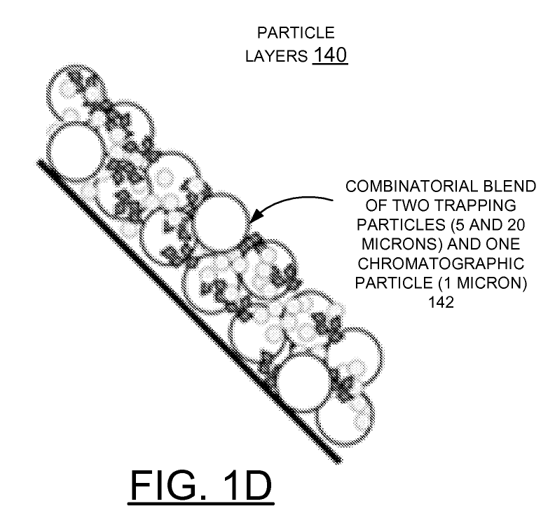

Having reference now to the drawings, FIGS. 1A, 1B, 1C, and 1D illustrate an exemplary rotating rod renewable microcolumn for implementing methods in accordance with the preferred embodiment. It should be understood that the particle sizes are illustrative and are not meant to be restrictive or necessarily a preferred embodiment. It should be understood that the particle trapping mechanism is not limited to a rotating rod fluidic restriction.

### Physical/Mechanical Column Formation

Referring to FIG. 1A, there is shown an exemplary rotating rod renewable microcolumn for implementing methods in accordance with the preferred embodiment and generally designated by the reference numeral 100. The rotating rod renewable microcolumn 100 includes a flow path 102 from an inlet 104 to an outlet 106. A flow cell casing 108 defines the flow path 102, inlet 104, and outlet 106 and receives a rotating rod 110.

The rotating rod renewable microcolumn 100 advantageously is of the type described in the above-identified U.S. Pat. No. 7,090,774, and divisional patent application US 2006/0096903 A1. The subject matter of the rotating rod renewable microcolumn of the above-identified U.S. Pat. No. 7,090,774 is incorporated herein by reference.

In accordance with features of the invention, the technical problem solved is to create a packed column of 1 micron silica particles within a flow cell having fluidic tolerances of approximately 20 microns, as shown in FIG. 1A. If we simply use a first layer of beads with a nominal diameter of 20 microns, and then attempt to create a second layer of 1 micron beads behind the 20 micron beads as shown in U.S. Pat. No. 7,090,774, and divisional patent application US 2006/0096903 A1, the 1 micron beads escape from the flow cell between the pores of the 20 micron filter layer.

Referring to FIG. 1B, there is shown exemplary particle layers for implementing methods in accordance with the preferred embodiment and generally designated by the reference numeral 120. Particle layers 120 include a layer of 1 micron beads 122, a 5 micron trapping layer 124, and a trapping layer 126 of 20 micron beads. By introducing the additional trapping layer 124 of approximately 5 micron particles prevents the loss of 1 micron particles from the flow cell and fluidic system 100 of FIG. 1A.

Referring to FIG. 1C, there is shown exemplary particle layers for implementing methods in accordance with the preferred embodiment and generally designated by the reference numeral 130. Particle layers 130 include a blended layer 132 of 5 micron beads or trapping particles and 1 micron chromatographic beads defining the blended layer 132, and a trapping layer 134 of 20 micron beads. By introducing the additional blended layer 132 of 5 micron trapping particles and 1 micron chromatographic particles prevents the loss of 1 micron particles from the flow cell and fluidic system 100 of FIG. 1A.

Referring to FIG. 1D, there is shown an exemplary particle layer for implementing methods in accordance with the preferred embodiment and generally designated by the reference numeral 140. Particle layer 140 includes all 3 particle types including 5 micron and 20 micron trapping particles, and 1 micron chromatographic particles defining a blended layer 142. The blended layer 142 prevents the loss of 1 micron particles from the flow cell and fluidic system 100 of FIG. 1A.

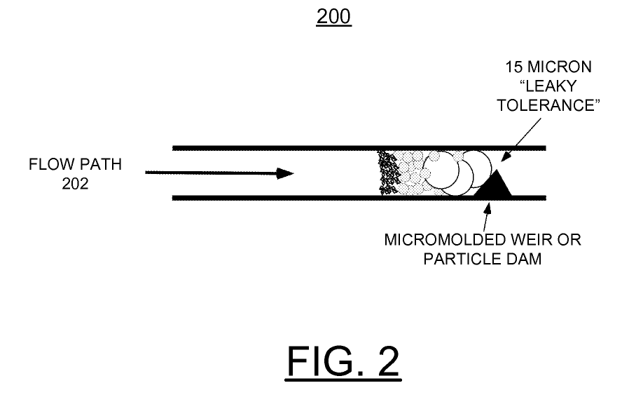

FIG. 2 illustrates the identical functionality within an injection-molded microfluidic piece generally designated by the reference numeral 200 rather than a renewable microcolumn of FIGS. 1A, 1B, 1C, and 1D. The injection-molded microfluidic piece 200 defines a flow path 202 through a combinatorial column packing/formation within the microfluidic structure. The injection-molded microfluidic piece 200 includes, for example, a “layered” deposition strategy. Blended layers have also been demonstrated. In one embodiment, 3 micron paramagnetic particles were successfully trapped and retained behind a blended layer of 20 and 5 micron polystyrene particles.

### Physical/Mechanical Filtration

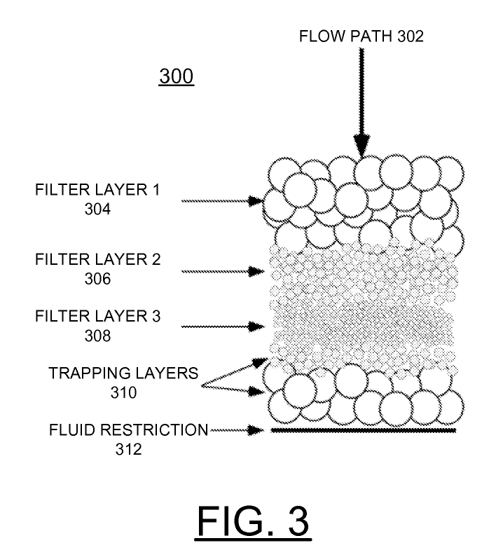

FIG. 3 illustrates a combinatorial filtration microcolumn for implementing methods in accordance with the preferred embodiment and generally designated by the reference numeral 300. The combinatorial filtration microcolumn 300 includes a flow path 302 through multiple layers. The combinatorial filtration microcolumn 300 includes a filter layer 1, 304, a filter layer 2, 306, a filter layer 3, 308, a pair of trapping layers 310 of, for example, 20 micron and 5 micron trapping layers, and a fluid restriction 312.

Given that it is possible to form packed microcolumns with particles of varied physicochemical properties, it is then possible to create varied microcolumn geometries for physical/mechanical separations. Separations or filtrations of interest include but are not limited to bulk filtration, as commonly practiced with membrane-based filters of defined pore size or molecular weight cutoff values, or size exclusion chromatography, as commonly practiced with particle types, such as sepharose, a bead-form of agarose (a polysaccharide polymer material extracted from seaweed) or Sephadex, a trademark for cross-linked dextran gel. In one embodiment, it is thus possible to create a combinatorial filtration microcolumn as illustrated in FIG. 3.

In this example of FIG. 3, a generic microcolumn 300 is created within a disposable, re-useable or renewable surface flow cell consisting of 3 particles of disparate cross-section in respective filter layers 1-3, 304, 306, 308, where the pore size created within each layer of the microcolumn differs with respect to subsequent layers. Thus, “large” particles or molecules are retained or impeded in the first layer with respect to the flow path; “medium” particles or molecules are retained or impeded in the second layer with respect to the flow path; and “small” particles or molecules are retained or impeded in the second layer with respect to the flow path. The insoluble particles within a sample solution may be tissue fragments, bacteria, and viruses, for example; the “molecules” within a sample solution may be any soluble molecule (organic, inorganic or biological chemical) of any molecular weight.

In accordance with features of the invention, as is also immediately understood by those skilled in the art, that substantially any number of disparate particle sizes and shapes could be thus utilized to create any number of layers, size-filtration zones or sequence of filtration zones within the microcolumn 300, regardless of whether or not multiple layers 310 of trapping beads are required in order to form the column within a fluidic structure. In yet another embodiment, it is possible to create a combinatorial microcolumn 300 consisting of particles of similar size, yet the particles themselves containing different pore sizes that are thus used for mechanical filtration. It will be understood to those skilled in the art that the size exclusion particles need not be uniform in size or shape, and that such particles can also be utilized to create to create any number of layers, size-filtration zones or sequence of filtration zones within the microcolumn 300.

### Modifying Flow Properties

For those skilled in the art, it is understood that certain chromatographic particles and column geometries are restricted in their use due to unacceptable fluidic backpressure or flow rates within the microfluidic system. It is also known that certain particles are more efficacious for inducing turbulent flow, thereby increasing mass transport and reaction rates within a microcolumn.

For example, agarose or sepharose particles are very “soft” and may be irrevocably compacted within a microfluidic device or within the leaky tolerance of the flow cell. For example, silica particles of approximately 1 micron in cross section will also compact upon buffer exchange. It is also well known that small particles generate higher fluidic backpressure in microcolumns than do large particles, irrespective of the chemistry or separations of interest.

In accordance with features of the invention, methods enable adjusting flow properties within microfluidic systems in order to make use of certain chromatographic particles for biological or chemical separations.

Referring also to FIGS. 1A, 1B, 1C, 1D, 2, and 3, it should be understood that the particle shapes, sizes, compositions and porosity are configured for the purpose of modifying fluidic pressure within the microcolumn.

Referring to FIG. 1B, for example, a layer of 1 micron silica microparticles is physically trapped by the combinatorial layering strategy; however, the entire microcolumn and fluidic system may fail upon buffer exchange from chaotropic to wash solutions due to particle cementation and excessive backpressure.

Referring to FIG. 1D, however, the blended particle layer 142 provides enough physical separation between 1 micron silica particles such that the microcolumn does not cement upon buffer exchange, enabling the specific 1 micron silica particles to be utilized for nucleic acid separations within a microfluidic system.

In the embodiment, illustrated in FIG. 3, Filter Layers 1 and 2, 304, 306 are used to reduce the pressure drop across the chromatographic particles of interest (i.e. Filter Layer 3, 308), enabling the particles composing Filter Layer 3, 308 to be used within the microfluidic separations system where they would otherwise be unusable in the absence of Filter Layers 1 and 2, 304, 306. In like manner, discreet particle layers or blended layers (as shown in FIGS. 1B, 1C, 1D) are used to introduce varying turbulent flow properties within the microcolumn, increasing reaction rates and kinetics upon the chromatographic particles of interest.

### Combinatorial Chemical Separations

In accordance with features of the invention, as will be understood by those skilled in the art, a generic combinatorial column, for example, as shown in FIGS. 1A, 1B, 1C, 1D, 2, and 3, advantageously is composed of particles of different affinity or chemical compositions, such that a combinatorial chemical separation becomes possible within a single microcolumn.

In one embodiment and referring to FIG. 3, for example, Filter Layer 1 may be composed of polyvinylpolypyrrolidone (PVPP) for removing humic substances from a sample; Filter Layer 2 may be composed of protein-A or antibody-coated particles for isolating and concentrating cells, viruses or proteins; and Filter Layer 3 may be composed of oligonucleotide-coated or silica particles for nucleic acid concentration and purification. Selective or sequential removal of the differing classes of captured molecules from the microcolumn may be accomplished via buffer exchanges, solvents, heat, pH gradients or other chromatographic principles common to those skilled in the art. Likewise, the combinatorial chemical separation is not exclusive to biological molecules, but may be extended to any class of molecules of interest in both “layered” and “blended” combinatorial packing strategies (i.e. FIGS. 1A, 1B, 1C, 1D, and 2).

In accordance with features of the invention, as will also be understood by those skilled in the art that the combinatorial microcolumn 300 of FIG. 3 advantageously embodies both physical/mechanical and chemical separations within one and the same flow cell. For example, Filter Layer 1, 304 implements a mechanical filter to remove insoluble debris from a sample, while Filter Layer 2, 306 and Filter Layer 3, 308 perform disparate chemical separations. Again, it will be understood by those skilled in the art that the number and types of particles that may be combined in a combinatorial microcolumn are, in principle, unlimited.

While the present invention has been described with reference to the details of the embodiments of the invention shown in the drawing, these details are not intended to limit the scope of the invention as claimed in the appended claims.

What is claimed is:

1. A renewable chromatography structure for capturing specific molecules in a microfluidic environment comprising:
a microfluidic column containing a mixture of particles of selected chemistry;
said mixture including small particles having a diameter smaller than a fluidic tolerances of the microfluidic column; and
said mixture provided in a particle layer structure for manipulating and trapping said small particles within the microfluidic column.

2. A renewable chromatography structure for capturing specific molecules in a microfluidic environment as recited in claim 1 wherein said small particles having a diameter smaller than a fluidic tolerances of the microfluidic column are less than 5 microns in diameter.

3. A renewable chromatography structure for capturing specific molecules in a microfluidic environment as recited in claim 1 wherein said particle layer structure for manipulating and trapping said small particles within the microfluidic column includes at least one trapping layer.

4. A renewable chromatography structure for capturing specific molecules in a microfluidic environment as recited in claim 3 wherein said particle layer structure includes a plurality of particle layers including a layer of said small particles.

5. A renewable chromatography structure for capturing specific molecules in a microfluidic environment as recited in claim 3 wherein said particle layer structure includes a plurality of particle layers including a blended layer including said small particles and selected trapping particles.

6. A renewable chromatography structure for capturing specific molecules in a microfluidic environment as recited in claim 3 wherein said at least one trapping layer is a blended layer including a combinatorial blend of two trapping particles and said small particles.

7. A renewable chromatography structure for capturing specific molecules in a microfluidic environment as recited in claim 1 wherein said mixture of particles of selected chemistry are used for physical packing, filtration, and modifying fluidic flow properties of said microfluidic column.

8. A renewable chromatography structure for capturing specific molecules in a microfluidic environment as recited in claim 1 wherein said microfluidic column is a renewable chromatography column.

9. A renewable chromatography structure for capturing specific molecules in a microfluidic environment as recited in claim 1 wherein said microfluidic column is a rotating rod renewable chromatography column.

10. A renewable chromatography structure for capturing specific molecules in a microfluidic environment as recited in claim 1 wherein said particle layer structure enables performing discreet chromatographic functions in series utilizing said mixture of particles of selected chemistry.

11. A renewable chromatography structure for capturing specific molecules in a microfluidic environment as recited in claim 1 wherein said particle layer structure enables performing discreet chromatographic functions in series and in combination utilizing said mixture of particles of selected chemistry.

12. A renewable chromatography structure for capturing specific molecules in a microfluidic environment as recited in claim 1 wherein said mixture of particles of selected chemistry includes at least two particles of differing physiochemical composition contained within said microfluidic column.

13. A renewable chromatography structure for capturing specific molecules in a microfluidic environment as recited in claim 1 wherein said particle layer structure is selectively arranged for modifying flow based upon said small particles.

14. A renewable chromatography structure for capturing specific molecules in a microfluidic environment as recited in claim 1 wherein said particle layer structure is selectively arranged for separating multiple chromatographic layers within said microfluidic column.

15. A renewable chromatography structure for capturing specific molecules in a microfluidic environment as recited in claim 1 wherein said small particles have a diameter of about 1 micron.

16. A method of using of a renewable chromatography column to capture specific molecules in a microfluidic environment comprising the steps of:
providing a microfluidic column containing a mixture of multiple particles, each having selected chemistry;
providing small particles having a diameter smaller than a fluidic tolerances of the microfluidic column within said mixture; and
providing a particle layer structure for said mixture for manipulating and trapping said small particles within the microfluidic column.

17. A method of using of a renewable chromatography column to capture specific molecules in a microfluidic environment as recited in claim 16 includes selectively arranging said particle layer structure for separating multiple chromatographic layers within said microfluidic column.

18. A method of using of a renewable chromatography column to capture specific molecules in a microfluidic environment as recited in claim 16 includes selectively arranging said particle layer structure for performing discreet chromatographic functions in series utilizing said mixture of particles of selected chemistry.

19. A method of using of a renewable chromatography column to capture specific molecules in a microfluidic environment as recited in claim 16 includes selectively arranging said particle layer structure for performing discreet chromatographic functions in series and in combination utilizing said mixture of particles of selected chemistry.

20. A method of using of a renewable chromatography column to capture specific molecules in a microfluidic environment as recited in claim 16 includes selectively arranging said particle layer structure for modifying flow based upon said small particles.
